(19) United States
(12) Patent Application Publication
(10) Pub. No.: US 2004/0038130 A1
(43) Pub. Date: Feb. 26, 2004

(54) Lithium secondary battery

(76) Inventors: Naoki Imachi, Kobe-city (JP); Seiji Yoshimura, Kobe-city (JP)

Correspondence Address: KUBOVCIK & KUBOVCIK, SUITE 710, 900 17TH STREET NW, WASHINGTON, DC, 20006

(21) Appl. No.: 10/646,810

(22) Filed: Aug. 25, 2003

(30) Foreign Application Priority Data
Aug. 26, 2002 (JP) 2002-244912

(51) Int. Cl. H01M 2/16; H01M 10/40

(52) U.S. Cl. 429/250; 429/330; 429/333; 429/332

(57) ABSTRACT

A lithium secondary battery including a positive electrode which is capable of occluding and releasing lithium, a negative electrode which is capable of occluding and releasing lithium, a separator between the positive electrode and the negative electrode, and a nonaqueous electrolyte comprising a nonaqueous solvent and a wettability improving agent. The nonaqueous solvent does not substantially wet the separator, and the wettability improving agent is dissolved in the nonaqueous solvent, improves the wettability of the nonaqueous solvent to the separator, and has an oxidative decomposition potential in a range of 4.5 V to 6.2 V.

### FIELD OF THE INVENTION

The present invention relates to a lithium secondary battery. More particularly, the present invention relates to a lithium secondary battery having improved safety.

### BACKGROUND OF THE INVENTION

A lithium secondary battery is useful as a power source for electronic equipment because it is compact and lightweight and has high energy density. Especially, a lithium secondary battery using lithium cobalt oxide as an active material for a positive electrode material has excellent high energy density and for that reason it is useful as a driving power source for portable electronic equipment. However, lithium cobalt oxide is likely to be decomposed by overcharging. Therefore, when a lithium secondary battery using lithium cobalt oxide is assembled, an external safety mechanism such as a battery protective circuit is included to prevent an accident, for example, explosion, fire, or the like, caused by decomposition of lithium cobalt oxide. However, such a circuit is expensive and the cost of a battery having the circuit becomes high. Extra space required for the circuit is also a problem for making electronic equipment smaller and lighter.

Lithium manganate having a spinel structure does not readily decompose even during overcharging. Therefore, a battery using lithium manganate as an active material for a positive electrode has high safety without an external safety mechanism and the cost of a battery can be reduced. However, the capacity of a battery using lithium lithium manganate is much smaller than that of the former battery, and characteristics of the battery are remarkably deteriorated at a high temperature. These disadvantages are related to the nature of lithium manganate and cannot be easily overcome.

It is strongly required to develop an inexpensive and high capacity lithium secondary battery which utilizes the merits of lithium cobalt oxide and has sufficient safety without an external safety mechanism.

In light of such background, it has been proposed to use γ-butyrolactone as an electrolyte to improve the safety of a battery at high temperature or at overcharge (for example, Japanese Patent Nos. 3213407 and 3191912). However, even if a battery uses γ-butyrolactone, sufficient safety at overcharge cannot be obtained as compared with a battery using lithium manganate.

Conventionally, a polyolefin fine porous separator is used to shut down an overcharge current. That is, when a temperature reaches 120˜130° C. due to heat generated by progressing of overcharging, the separator melts and the poles are closed. However, if an overcharge current is supplied so as to reach such temperature, depending on the rate of charge, it happens that the battery explodes or ignites by progressing of a thermal runaway reaction between the positive electrode active material and an electrolyte. Therefore, it is desired to develop a means to shut down the current at an early stage of overcharge.

### OBJECT OF THE INVENTION

An object of the present invention is to solve the above described problems and to provide a lithium secondary battery which maintains high energy density and high capacity and has sufficient safety at overcharge and does not require an external safety mechanism.

### SUMMARY OF THE INVENTION

A lithium secondary battery of the present invention includes a positive electrode which is capable of occluding and releasing lithium, a negative electrode which is capable of occluding and releasing lithium, a separator between the positive electrode and the negative electrode, and a nonaqueous electrolyte comprising a nonaqueous solvent and a wettability improving agent,

wherein the nonaqueous solvent does not substantially wet the separator, and

the wettability improving agent is dissolved in the nonaqueous solvent, improves the wettability of the nonaqueous solvent to the separator, and has an oxidative decomposition potential in a range of 4.5 V to 6.2 V based on the potential of a lithium reference electrode.

### BRIEF DESCRIPTION OF THE DRAWINGS

FIG. 1 is a graph showing changes of battery capacity, current and surface temperature with time of a battery of Example 1.

FIG. 2 is a graph showing a Cole-Cole plot of the battery of Comparative Example 5 on which the impedance is plotted on a complex plane at each charge voltage point.

FIG. 3 is a graph showing a Cole-Cole plot on which the impedance of the battery of Example 1 is plotted on a complex plane at each charge voltage point.

FIG. 4 is a graph showing a Cole-Cole plot of the battery of Comparative Example 16 on which the impedance is plotted on a complex plane at each charge voltage point.

FIG. 5 is a graph showing a Cole-Cole plot on which the impedance of the battery of Example 12 is plotted on a complex plane at each charge voltage point.

### DETAILED EXPLANATION OF THE INVENTION

The wettability improving agent improves the wettability between the separator and the nonaqueous electrolyte and allows a smooth exchange of lithium ions between the positive and negative electrodes through the separator to facilitate charge and discharge of the battery. When a positive electrode potential is excessively increased (normal potential is not greater than 4.3 V) by overcharging, the wettability improving agent is decomposed by oxidative decomposition and loses its wettability effectiveness and wettability between the separator and the nonaqueous electrolyte is reduces. As a result, lithium ions cannot pass through the separator and an ion exchange reaction between the positive and negative electrodes stops and forcibly shuts down an overcharge current. This prevents generation of gas and ignition of a battery which are caused by a thermal runaway reaction between the electrodes and the electrolyte (this effect is referred to as the shut-down effect of the separator).

In the present invention, an upper limit of an oxidative decomposition potential of the wettability improving agent is designed to be lower than that of a normal nonaqueous solvent. Therefore, the wettability improving agent starts to decompose before the nonaqueous solvent decomposes and the above-described shut-down effect works. An increase in internal pressure that is caused by decomposition of the nonaqueous solvent, which is the major portion of the electrolyte, can be prevented. This makes it possible to provide a battery having excellent safety at overcharge without using an external safety mechanism such as a protective circuit.

Wettability in the present application is measured by a method of evaluation of wettability described below.

In a lithium secondary battery of the present invention, an oxidative decomposition potential of the wettability improving agent can be lower than that of the nonaqueous solvent.

If the battery is designed as described above, the wettability improving agent decomposes before the nonaqueous solvent decomposes to cause shut down of an overcharge current and to prevent generation of gas and heat.

In the lithium secondary battery of the present invention, reductive decomposition potential can be not greater than 0.0 V, measured using lithium as a reference electrode.

As a negative electrode active material for the lithium secondary battery, lithium alloy, carbon, a metal oxide, or a mixture thereof, which is capable of occluding and releasing lithium ions can be used. A graphite carbon material is commonly used because it has a high capacity. A battery voltage is defined as a difference in potential between the positive electrode and the negative electrode. When the battery is charged and is discharged, a negative electrode potential is normally in a range of 0.0˜3.0 V depending on the negative electrode active material. When graphite is used as the negative electrode active material, the negative electrode potential when the battery is charged is 0.0 V. Therefore, according to the above-described arrangement, even if graphite is used as the negative electrode active material, the wettability improving agent does not undergo reductive decomposition during normal charge and discharge of the battery and the battery has excellent cycle characteristics (battery capacity maintenance rate).

In the lithium secondary battery of the present invention, a mass ratio of the wettability improving agent to the nonaqueous solvent is not greater than 3.0 mass (weight) %.

If the wettability improving agent is contained in an amount of more than 3.0 mass (weight) % relative to the nonaqueous solvent, it takes time for the oxidative decomposition of the wettability improving agent during overcharging to occur and shutting down of the separator, which occurs by the extinguishing of the wettability improving effect of the wettability improving agent, is delayed.

In the lithium secondary battery of the present invention, the oxidative decomposition potential of the wettability improving agent can be 4.8 V or more and not greater than 5.2 V measured on the basis of the potential of a lithium reference electrode.

If the oxidative decomposition potential of the wettability improving agent is in the range described above, the lower limit of the oxidative decomposition potential of the wettability improving agent of 4.8 V is sufficiently high as compared with the range of potential of the positive electrode, which is normally about 2.75 V˜4.3 V, and charging of the battery is not compulsorily stopped in response to a change of battery voltage during charge. In addition to this fact, the upper limitation of the oxidative decomposition potential of the wettability improving agent of 5.2 V is sufficiently lower than an oxidative decomposition potential of the solvent of a conventional nonaqueous electrolyte, that the wettability improving agent starts to decompose before the nonaqueous solvent decomposes so as to exhibit the shut down effect of the separator. This design make it possible to provide a battery which has a properly working self-operating safety mechanism.

There is no limitation of the shape of the battery of the present invention. The battery can have various shapes, for example, cylindrical, rectangular, a coin shape, and the like.

As will be understood by those skilled in the art, the battery of the present invention can be assembled by various procedures such as that described in the following Examples.

There is no limitation with respect to the material of the separator. However, a melting point of the separator is preferably higher than the decomposition temperature of the wettability improving agent. Regarding the structure of the separator, there is also no limitation with respect to porosity, size of holes, and internal structure if the separator is porous and ions can pass through. Unwoven fabric, fine porous material, and the like can be exemplified.

As a positive electrode active material, lithium cobalt is preferable from the standpoint of energy density. However, LiₓMO₂ (M is Ni, Fe, V or Mo), LiMOS₂, LiMPO₄, lithium manganese composite oxide, a spinel lithium manganate is a typical example, LiCoₓNi₁₋ₓO₂, LiTiO₂, LiₓVO_{y}, (wherein x and y is a number corresponding to each element of the chemical composition) and the like are also useful.

There is no limitation with respect to the solute of the electrolyte. In addition to LiBF₄, LiClO₄, LiPF₆, LiN(SO₂CF₃)₂, LiN(SO₂C₂F₅)₂, LiPF₆₋ₓ(CₙF₂ₙ₊₁)ₓ (wherein 123 x≦6 and n=1 or 2), and the like, can be used, alone or in combinations thereof. There is also no limitation with respect to the concentration of the solute. However, 0.2˜1.5 mol/l with respect to the electrolyte is preferred.

As the electrolyte solvent, if the solvent itself does not have wettability to the separator, and is difficult to decompose at a positive electrode potential at the initial stage of overcharge of the battery, it can be used for the present invention. Concretely, cyclic carbonates, for example, ethylene carbonate, propylene carbonate, butylene carbonate, and the like; and cyclic esters, for example, γ-butyrolactone, γ-valerolactone, and the like, can be used alone or in combinations thereof. When a mixed solvent is used, the combination of the solvents can be a combination of a cyclic carbonate and a cyclic ester, a combination of cyclic carbonates, a combination of cyclic carbonates and a cyclic ester, and the like. There is no limitation with respect to a mixing rate of components of the mixed solvent. However, when the cyclic carbonate and the cyclic ester are mixed, it is preferred to use a mixed ratio of 10:90˜40:60 from the aspects of penetration of the electrolyte into the electrodes and effect on battery characteristics.

There is no limitation with respect to the compound to be used as the wettability improving agent if the compound improves wettability of the electrolyte to the separator and is easily decomposed at an initial potential of overcharge of the battery.

The nonaqueous electrolyte battery of the present invention can be a polymer battery using a gel electrolyte. As a polymer material, polyether solid polymer, polycarbonate solid polymer, polyacrylonitrile solid polymer, copolymers thereof and crosslinked polymers can be illustrated. A solid electrolyte prepared from a mixture of the polymer material, lithium salt and electrolyte can be used. A mixing ratio of the polymer material and the electrolyte solution in a ratio by mass of 1:6˜1:25 is preferable from the aspects of conductivity and solvent maintenance characteristics.

### DESCRIPTION OF PREFERRED EMBODIMENT

Examples of the present invention are described below and are compared with comparative examples. Also, batteries prepared in the Examples and Comparative Examples were applied to Experiments 1˜5 to show the effects of the present invention. It is of course understood that the present invention is not limited to these embodiments, but can be modified within the scope and spirit of the appended claims.

### EXAMPLE 1

A lithium secondary battery of Example 1 was prepared as described below.

Preparation of Positive Electrode

Lithium cobalt oxide as a positive electrode active material and graphite as a carbon conductive agent were mixed at a ratio by mass of 92:5 to prepare a positive electrode mixture powder. The positive electrode mixture powder was applied to a mechanofusion apparatus (Hosokawa Micron Co. Model No. AF-15F), and the apparatus was operated at 1,500 rpm for ten minutes to apply pressure, impact and shear force to the powder. Then the positive electrode mixture powder was mixed with polyvinylidene fluoride (PVDF) as a fluorine resin binder in N-methylpyrrolidone (NMP) in a ratio by mass of 97:3 to make a slurry. Then the slurry was coated on both sides of an aluminum foil and dried, and was pressure rolled to prepare a positive electrode sheet.

Preparation of Negative Electrode

Natural graphite as a negative electrode active material and styrene-butadiene rubber (SBR) as a binder were mixed at a ratio by mass of 98:2 to form a mixture. The mixture was coated on both sides of a copper foil and dried, and was pressure rolled to prepare a negative electrode sheet.

Preparation of Electrolyte

1.5 mol/l LiBF₄ was dissolved in a mixture of ethylene carbonate (EC) and γ-butyrolactone (GBL) in a ratio by volume of 3:7. 3 mass % of 1,2-dimethoxyethane (DME) ethane as the wettability improving agent was added to the solvent to prepare an electrolyte including the wettability improving agent.

Assembly of Battery

The positive and negative electrodes with leads mounted thereon and a separator made of polyethylene (2.5 cm×2.0 cm×23 μm, porosity of 53%) was rolled and placed in an outer battery can made of an aluminum laminate. After the pressure in the outer battery can was reduced to ⅓ of normal pressure, the electrolyte was poured into the can and the can was sealed to prepare a thin battery having a theoretical capacity of 700 mAh.

### EXAMPLE 2

A battery of Example 2 was prepared in the same manner as the battery of Example 1 except that tetrahydrofuran (THF) was used instead of 1,2-dimethoxyethane (DME).

### EXAMPLE 3

A battery of Example 3 was prepared in the same manner as the battery of Example 1 except that 2-methyltetrahydrofuran (2-MeTHF) was used instead of 1,2-dimethoxyethane (DME).

### EXAMPLE 4

A battery of Example 4 was prepared in the same manner as the battery of Example 1 except that 1,3-dioxolane (DOL) was used instead of 1,2-dimethoxyethane (DME).

### EXAMPLE 5

A battery of Example 5 was prepared in the same manner as the battery of Example 1 except that 4-methyl-1,3-dioxolane (4-MeDOL) was used instead of 1,2-dimethoxyethane (DME).

### EXAMPLE 6

A battery of Example 6 was prepared in the same manner as the battery of Example 1 except that N,N-dimethylformamide (DMF) was used instead of 1,2-dimethoxyethane (DME).

### EXAMPLE 7

A battery of Example 7 was prepared in the same manner as the battery of Example 1 except that N-methylpyrrolidone (NMP) was used instead of 1,2-dimethoxyethane (DME).

### EXAMPLE 8

A battery of Example 8 was prepared in the same manner as the battery of Example 1 except that methyl formate (MF) was used instead of 1,2-dimethoxyethane (DME).

### EXAMPLE 9

A battery of Example 9 was prepared in the same manner as the battery of Example 1 except that dimethyl sulfoxide (DMSO) was used instead of 1,2-dimethoxyethane (DME).

### COMPARATIVE EXAMPLE 1

A battery of Comparative Example 1 was prepared in the same manner as the battery of Example 1 except that 1,2-dimethoxyethane (DME) was not contained in the electrolyte.

### COMPARATIVE EXAMPLE 2

A battery of Comparative Example 2 was prepared in the same manner as the battery of Example 1 except that ethylene carbonate (EC) was used instead of 1,2-dimethoxyethane (DME).

### COMPARATIVE EXAMPLE 3

A battery of Comparative Example 3 was prepared in the same manner as the battery of Example 1 except that propylene carbonate (PC) was used instead of 1,2-dimethoxyethane (DME).

### COMPARATIVE EXAMPLE 4

A battery of Comparative Example 4 was prepared in the same manner as the battery of Example 1 except that γ-butyrolactone (GBL) was used instead of 1,2-dimethoxyethane (DME).

### COMPARATIVE EXAMPLE 5

A battery of Comparative Example 5 was prepared in the same manner as the battery of Example 1 except that trioctyl phosphate (TOP) was used instead of 1,2-dimethoxyethane (DME).

### COMPARATIVE EXAMPLE 6

A battery of Comparative Example 6 was prepared in the same manner as the battery of Example 1 except that diethyl carbonate DEC was used instead of 1,2-dimethoxyethane (DME).

### COMPARATIVE EXAMPLE 7

A battery of Comparative Example 7 was prepared in the same manner as the battery of Example 1 except that dimethyl carbonate (DMC) was used instead of 1,2-dimethoxyethane (DME).

### COMPARATIVE EXAMPLE 8

A battery of Comparative Example 8 was prepared in the same manner as the battery of Example 1 except that ethyl methyl carbonate (EMC) was used instead of 1,2-dimethoxyethane (DME).

### COMPARATIVE EXAMPLE 9

A battery of Comparative Example 9 was prepared in the same manner as the battery of Example 1 except that methyl acetate (MA) was used instead of 1,2-dimethoxyethane (DME).

The following experiments 1 and 2 were conducted using the batteries of Examples 1˜9 and Comparative Examples 1˜9 to obtain relationships of the additives having wettability improving effects, electrochemical characteristics of the additives, characteristics of the batteries including the additives, and the safety of the batteries.

[Experiment 1]

Wettability of the separators of the batteries of Examples 1˜9 and Comparative Examples 1˜9 were evaluated by a method described below. Also oxidative-reductive decomposition potentials of the additives added to the solvent were measured by a method described below. The results are shown in Table 1.

Evaluation of Wettability

A separator (2.5 cm×2.0 cm) having a mass (W0) was immersed in 2 ml of an electrolyte, pressure was reduced from 1013 hPa to 338 Hpa at 25° C. and was maintained under this condition for 5 minutes and then the pressure was returned to 1013 hPa for 4 minutes. After this process was repeated four times, the separator was lifted 20 cm from the surface level of the electrolyte for 2 minutes and its mass (W1) was measured. A mass change rate was calculated from expression (1) below. When the mass change rate is not greater than 5%, it was evaluated as X (there is no substantial wettability), when the change is more than 5% but less than 30%, it was evaluated as A, when the change is 30% or more, it was evaluated as ◯ (there is wettability). A wettability improving agent in the present invention is defined as one that, when the agent is dissolved in a solvent which is evaluated as not having substantial wettability, an electrolyte containing the additive is evaluated as having wetability (◯). A mass of the separator used in the Examples (W0) was 61 mg.

An additive means a compound which is added to a solvent regardless of whether or not it has wettability. Thus the additive includes a compound evaluated as X, Δ or ◯.

Mass change rate (%)={(W1−W0)/W0)×100 (1)

Measurement of Oxidative-reductive Decomposition Potentials

A potentionstat which is normally used to measure electrochemical stability ranges was used to measure the oxidative decomposition potential and the reductive decomposition potential of the additives. A sample solution of each additive in which 0.65 mol/dm³ of Et₄NBF₄ or Bu₄NBF₄ was dissolved was placed into an apparatus which has glassy carbon as a working electrode and metal lithium as a reference electrode, and the working electrode and reference electrode were dipped in the sample solution to measure electrochemical stability ranges at a 5 mV/sec scan rate at 25° C. Oxidative-reductive decomposition potentials were obtained from the results of measurement of the electrochemical stability range.

[Experiment 2]

Batteries of Examples 1˜9 and Comparative Examples 5˜9 were evaluated for battery capacity and capacity maintenance rate, and an overcharge test was also conducted. The results are shown in Table 2. Details of the evaluation and test conditions are described below. The batteries of Comparative Examples 1˜4 did not exhibit wettability between the electrolytes and separators, and were eliminated from the evaluation.

Measurement of Battery Capacity

Batteries were charged at a charge current of 700 mA (1.0 It) to 4.0 V and were charged at a constant voltage of 4.0 V to provide a full charge. Then, after being left at room temperature for 10 minutes the batteries were discharged at a constant current of 700 mA (1.0 It) to an ending voltage of 2.75 V. A discharge capacity was calculated from the discharge time.

Measurement of Capacity Maintenance Rate

After the initial discharge capacity was obtained from the above-described measurement of battery capacity, ten cycles of charge and discharge were repeated under the same conditions as above. After the tenth cycle was completed, discharge capacity was measured and measurement of capacity maintenance rate was calculated according to expression (2) below.

$$\text{Capacity Maintenance Rate (\%)} = ( \text{discharge capacity after ten cycles} / \text{initial discharge capacity} ) \times 100$$

Overcharge Test

Fully charged batteries were constantly charged at a constant current of 2100 mA (3.0 It) to 12.0 V without a protective circuit. If an unusual incident, for example, release of contents, generation of smoke, explosion of the battery, ignition, or the like, occurred, the battery was considered “abnormal”, and if such unusual incident did not occur, it was considered “normal”.

A continuous charge test was conducted at a constant current of 1050 mA (1.5 It) for comparison. Five batteries of each Example and Comparative Example were used as samples. It is noted that it is believed that safety of a regular lithium ion secondary battery can be maintained at a charge current of 1.5 It.

TABLE 1

| | | Wettabil- | Oxidative | Reductive |
|---|---|---|---|---|
| | | ity | Decomposition | Decomposition |
| | Chemical | (Reduced | Potential | Potential |
| No. | Compound | Pressure) | (V) | (V) |
| Example 1 | DME | ◯ | 5.1 | 0.0 |
| Example 2 | THF | ◯ | 5.2 | 0.0 |
| Example 3 | 2-MeTHF | ◯ | 5.2 | 0.0 |
| Example 4 | DOL | ◯ | 5.2 | 0.0 |
| Example 5 | 4-MeDOL | ◯ | 5.2 | 0.0 |
| Example 6 | DMF | ◯ | 4.6 | 0.0 |
| Example 7 | NMP | ◯ | 4.6 | 0.0 |
| Example 8 | MF | ◯ | 5.4 | 0.5 |
| Example 9 | DMSO | ◯ | 4.5 | 0.1 |
| Comparative | None | X | — | — |
| Example 1 | | | | |
| Comparative | EC | X | 6.2 | 0.0 |
| Example 2 | | | | |
| Comparative | PC | X | 6.6 | 0.0 |
| Example 3 | | | | |
| Comparative | GEL | X | 8.2 | 0.0 |
| Example 4 | | | | |
| Comparative | TOP | ◯ | 6.5 | 0.0 |
| Example 5 | | | | |
| Comparative | DEC | ◯ | 6.7 | 0.0 |
| Example 6 | | | | |
| Comparative | DMC | ◯ | 6.7 | 0.0 |
| Example 7 | | | | |
| Comparative | EMC | ◯ | 6.7 | 0.0 |
| Example 8 | | | | |
| Comparative | MA | ◯ | 6.4 | 0.1 |
| Example 9 | | | | |

TABLE 2

| | | | Capacity | Abnor- | Abnor- |
|---|---|---|---|---|---|
| | Chemical | Capacity | Maintenance | mality | mality |
| No. | Compound | (mAh) | Rate (%) | (1.5 C) | (3 C) |
| Example 1 | DME | 701 | 99 | 0/5 | 0/5 |
| Example 2 | THF | 700 | 99 | 0/5 | 0/5 |
| Example 3 | 2-MeTHF | 702 | 99 | 0/5 | 0/5 |
| Example 4 | DOL | 698 | 99 | 0/5 | 0/5 |
| Example 5 | 4-MeDOL | 700 | 99 | 0/5 | 0/5 |
| Example 6 | DMF | 697 | 99 | 0/5 | 0/5 |
| Example 7 | NMP | 701 | 99 | 0/5 | 0/5 |
| Example 8 | MF | 490 | 32 | 0/5 | 0/5 |
| Example 9 | DMSO | 679 | 92 | 0/5 | 0/5 |
| Comparative | TOP | 698 | 99 | 0/5 | 5/5 |
| Example 5 | | | | | |
| Comparative | DEC | 701 | 99 | 0/5 | 5/5 |
| Example 6 | | | | | |
| Comparative | DMC | 700 | 99 | 0/5 | 5/5 |
| Example 7 | | | | | |
| Comparative | EMC | 699 | 99 | 0/5 | 5/5 |
| Example 8 | | | | | |
| Comparative | MA | 675 | 92 | 0/5 | 3/5 |
| Example 9 | | | | | |

It is understood that the nonaqueous solvent itself does not have wettability to the separator from the results of Comparative Example 1 shown in Table 1. It is also understood from the results of Comparative Examples 2˜4 that EC, PC and GBL do not work as a wettability improving agent. However, when DME, THF, 2-MeTHF, DOL, 4-MeDOL, DMF, NMP, MF, DMSO, TOP, DEC, DMC, EMC or MA was added to the nonaqueous solvent, wettability of the solvent to the separator was significantly improved. Please note that differences between Examples 1˜9 and Comparative Examples 1˜9 are the additives added to the electrolytes.

If the additives added to the solvents improved wettability of the solvent to the separator and if the additives have oxidative decomposition potential in a range of 4.5 V and 6.2 V (measured by reference electrode lithium potential), none of the five batteries of each Example showed any abnormality by an overcharge test at both charge currents, i.e., 1.5 It and 3.0 It. When the reductive decomposition potential of the additive is not greater than 0.0 V, battery capacity was very close to a theoretical capacity, i.e., 700 mAh, and capacity maintenance rate was 99%.

A battery of the present invention containing a wettability improving agent which is capable of improving wettability of a solvent to a separator and of which the oxidative decomposition potential is in a range of 4.5 V to 5.2 V relative to a reference electrode lithium potential can provide a shut down effect at an early stage of overcharge, and can avoid having to include a protective circuit to shut down a charge current. Furthermore, if the wettability improving agent has a reductive decomposition potential of not greater than 0.0 V, a battery having excellent energy efficiency and capacity maintenance characteristics over a long period can be obtained.

Batteries of Examples 8 and 9 which used a wettability improving agent having a reductive decomposition potential of more than 0.0 V had capacity maintenance rates that were lower than 99%. Causes of this phenomena are analyzed below.

Battery voltage is normally the difference between the potential of a positive electrode and the potential of a negative electrode. When a battery is charged and discharged, a negative electrode potential is in a range of 0.0˜3.0 V and a positive electrode potential is in a range of 2.75 V˜4.3 V. A negative electrode potential of the battery of Example 1 is extremely close to 0.0 V because graphite was used as a negative electrode active material. For the batteries of Examples 8 and 9 and Comparative Example 9 which used additives having a reductive decomposition potential of more than 0.0 V, battery capacity and capacity maintenance rate were reduced as the additives were gradually decomposed by reductive decomposition.

Batteries of Comparative Examples 5˜9 showed similar battery capacities and capacity maintenance rates to the batteries of Examples 1˜7. It is believed that the reductive decomposition potentials of the additives used in these Comparative Examples are 0.0 V. However, all batteries of these Comparative Examples had problems in the overcharge test at 3.0 It. Causes of these phenomena are analyzed below.

\mathring{1} Oxidative decomposition potentials of GBL and EC, which were used as main solvents in the Examples and Comparative Examples, are 8.2 V and 6.2 V, respectively, as shown in Table 1. Oxidative decomposition potentials of the additives in Examples 1˜7 are 4.6 V˜5.2 V and those of the additives in Comparative Examples 5˜9 are 6.5 V˜6.7 V. The oxidative decomposition potentials of the additives in Comparative Examples 5˜9 are higher than that of the main solvent, EC. Therefore, EC was decomposed before the overcharge current was stopped by decomposition of the additives. Abnormalities of the battery such as expansion of the battery by generated gas accompanied the decomposition of EC.

\mathring{2} The oxidative decomposition potentials of the additives in Comparative Examples 5˜9 are too high and overcharge became too extensive before the separators shut down and heat was unusually generated.

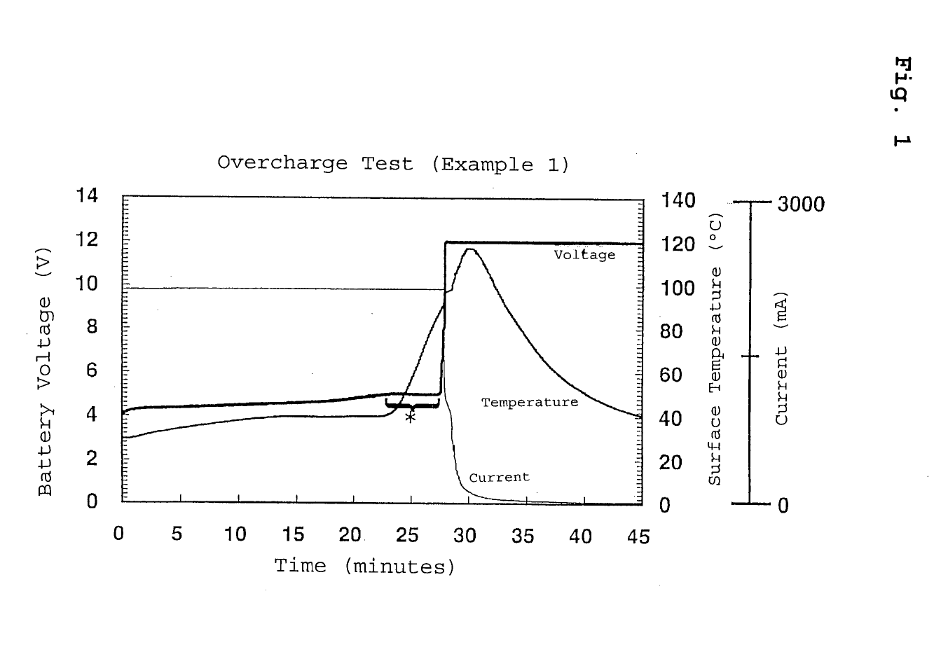

FIG. 1 is a graph showing changes of battery capacity, current and surface temperature of a battery with time of Example 1. In FIG. 1, a very heavy line shows the change of the battery voltage, a thin line shows the change of the current and a heavy line shows the change of the surface temperature of the battery. The vertical axis is the battery voltage (V), current (mA) and surface temperature of the battery (° C.). The horizontal axis is time (minutes) after start of application of the constant current. As shown in Table 2, this battery did not have problems such as ignition or explosion of the battery.

The surface temperature of the battery started to increase rapidly from 40° C. at 23 minutes after the start of application of constant current, and reached the highest temperature, 117° C., at 30 minutes after application of constant current. Then the temperature reduced gradually to 40° C. at 40 minutes after the start of application of constant current.

The voltage of the battery stayed around 5 V at 23˜27 minutes after start of application of constant current, and then increased extremely rapidly within 5 seconds to reach a steady level of 12 V.

The current stayed at 2100 mA until 27 minutes, then started dramatically dropping between 27˜30 minutes and reduced to 10 mA at 35 minutes after start of application of constant current.

Dramatic changes of voltage and current between 23˜27 minutes suggest that the internal resistance of the battery increased at that time. It is believed that the rapid increase of the internal resistance was caused by the shut down effect of the separator. There was a phenomenon of leveling off of voltage at around 5V (identified by “*” in the graph). This phenomenon is caused by decomposition of the wettability improving agent because the voltage is matched to the oxidative decomposition potential of the wettability improving agent (DME) used in Example 1, i.e., 5.1 V. The sudden increase of the battery voltage following this phenomenon was because the electrolyte lost wettability by decomposition of the wettability improving agent and the shut down effect of the separator occurred.

As explained below, the primary cause of the differences of safety obtained in the above-described overcharge test, based on the results of the measurement of internal resistance (impedance) in Example 1 and Comparative Example 5, is related to an increase of internal resistance.

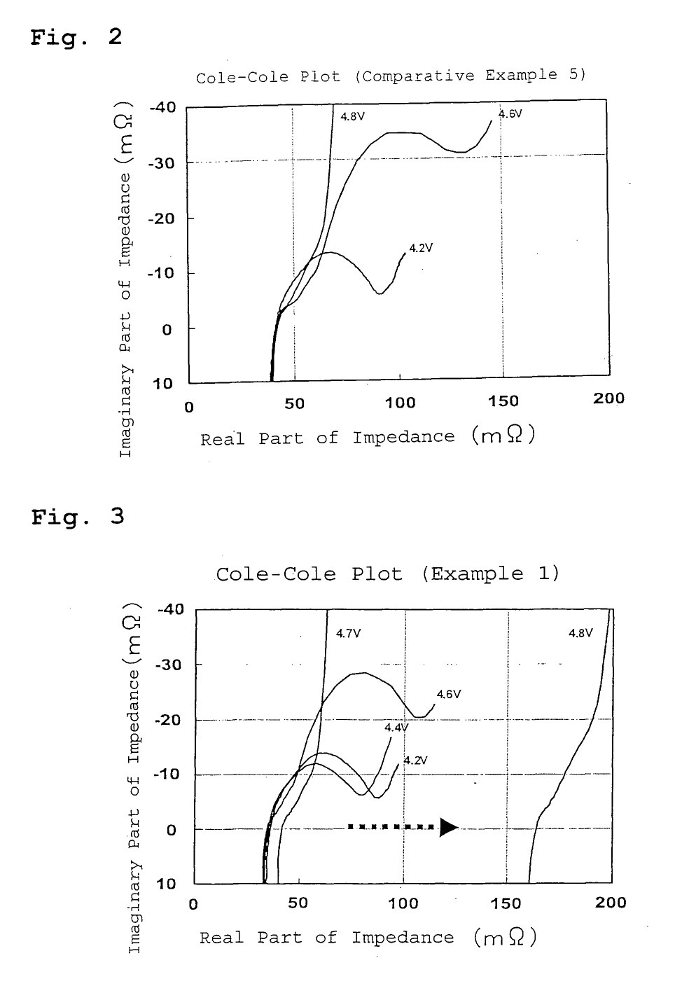

The batteries of Comparative Example 5 and Example 1 were charged to their charge voltage, 4.2 V˜4.8 V. The impedance of each of the batteries of Comparative Example 5 and Example 1 is shown in FIGS. 2 and 3, respectively. The impedance is plotted on a complex plane at each charge voltage point (Cole-Cole plot). The vertical axis is the imaginary part of impedance (mΩ) and the horizontal axis is the real part of impedance (mΩ).

It is generally considered that a value on the horizontal axis (bulk resistance) corresponding to “0” on the vertical axis on the Cole-Cole plot of each charge voltage point indicates resistance of an electrolyte in a separator. Therefore, increase of the bulk resistance indicates increase of shut down effect of the separator. A size of an arc on the Cole-Cole plots indicates the magnitude of interface resistance of an electrolyte and an electrode. Generally speaking, when a charge voltage becomes high, a reaction of an active material which has high reaction activity and an electrolyte progresses to increase the interface resistance and the arc on the Cole-Cole plot becomes greater.

As shown in FIG. 2, the bulk resistance of the battery of Comparative Example 5 did not increase in a range of 4.2 V˜4.8 V of the charge voltage and maintained a constant value, 41 mΩ. Therefore, it is believed that the shut down effect of the separator did not work in this range.

As shown in FIG. 3, the bulk resistance of the battery of Example 1 did not increase in a range of 4.2 V˜4.6 V of the charge voltage and maintained a constant value, 35 mΩ. When the charge voltage became greater than 4.7 V, the bulk resistance increased and increased to 168 mΩat 4.8 V, and a five times increase was noticed from 4.2 V˜4.8 V. Although not shown in FIG. 2, when the charge voltage was increased further, the bulk resistance increased at an increasing rate. Therefore, in the battery of Example 1, the shut down effect did not work until a battery voltage of 4.6 V was reached, but when the battery voltage increased beyond 4.6 V, the wettability improving agent was decomposed and the wettability of the separator was reduced and the shut down effect of the separator occurred.

Batteries of Examples 10 and 11 and Comparative Examples 10˜15 were prepared. Using these batteries the effect of the amount of a wettability improving agent on the capacity maintenance rate and battery safety were studied in Experiments 3 and 4.

### EXAMPLE 10

A battery of Example 10 was prepared in the same manner as the battery of Example 1 except that 0.5 mass % 1,2-dimethoxyethane (DME) was used instead of 3 mass %.

### EXAMPLE 11

A battery of Example 11 was prepared in the same manner as the battery of Example 1 except that 1 mass % 1,2-dimethoxyethane (DME) was used instead of 3 mass %.

### COMPARATIVE EXAMPLE 10

A battery of Comparative Example 10 was prepared in the same manner as the battery of Example 1 except that 5 mass % 1,2-dimethoxyethane (DME) was used instead of 3 mass %.

### COMPARATIVE EXAMPLE 11

A battery of Comparative Example 11 was prepared in the same manner as the battery of Example 1 except that 10 mass % 1,2-dimethoxyethane (DME) was used instead of 3 mass %.

### COMPARATIVE EXAMPLE 12

A battery of Comparative Example 12 was prepared in the same manner as the battery of Comparative Example 5 except that 0.5 mass % trioctyl phosphate (TOP) was used instead of 3 mass %.

### COMPARATIVE EXAMPLE 13

A battery of Comparative Example 13 was prepared in the same manner as the battery of Comparative Example 5 except that 1 mass % trioctyl phosphate (TOP) was used instead of 3 mass %.

### COMPARATIVE EXAMPLE 14

A battery of Comparative Example 14 was prepared in the same manner as the battery of Comparative Example 5 except that 5 mass % trioctyl phosphate (TOP) was used instead of 3 mass %.

### COMPARATIVE EXAMPLE 15

A battery of Comparative Example 15 was prepared in the same manner as the battery of Comparative Example 5 except that 10 mass % trioctyl phosphate (TOP) was used instead of 3 mass %.

[Experiment 3]

The electrolytes of the batteries of Examples 1, 10 and 11 and Comparative Examples 10˜15 were evaluated with respect to wettability to the separators. Wettability of each of the separators was measured as explained above in the section titled “Evaluation of Wettability” and was also measured at a condition of a normal pressure of 1013 hPa without a reduction of pressure during immersion the separator in the electrolyte. The results are shown in Table 3.

[Experiment 4]

The batteries of Examples 1, 10 and 11 and Comparative Examples 10˜15 were evaluated for battery capacity and capacity maintenance rate, and an overcharge test was also conducted. The results are shown in Table 4. Only the results obtained using a constant current of 3.0 It are shown in the table.

TABLE 3

| | | Added | Wettability | Wettability |
|---|---|---|---|---|
| Chemical | | Amount | (Reduced | (Normal |
| Compound | No. | (Mass %) | pressure) | pressure) |
| DME | Example 10 | 0.5 | ◯ | X |
| DME | Example 11 | 1 | ◯ | X |
| DME | Example 1 | 3 | ◯ | ◯ |
| DME | Comparative | 5 | ◯ | ◯ |
| | Example 10 | | | |
| DME | Comparative | 10 | ◯ | ◯ |
| | Example 11 | | | |
| TOP | Comparative | 0.5 | ◯ | ◯ |
| | Example 12 | | | |
| TOP | Comparative | 1 | ◯ | ◯ |
| | Example 13 | | | |
| TOP | Comparative | 3 | ◯ | ◯ |
| | Example 5 | | | |
| TOP | Comparative | 5 | ◯ | ◯ |
| | Example 14 | | | |
| TOP | Comparative | 10 | ◯ | ◯ |
| | Example 15 | | | |

TABLE 4

| | | Added | | | |
|---|---|---|---|---|---|
| | | Amount | | Capacity | Abnor- |
| Chemical | | (Mass | Capacity | Maintenance | malities |
| Compound | No. | %) | (mAh) | Rate (%) | (3 C) |
| DME | Example 10 | 0.5 | 699 | 99 | 0/5 |
| | Example 11 | 1 | 701 | 99 | 0/5 |
| | Example 1 | 3 | 701 | 99 | 0/5 |
| | Comparative | 5 | 700 | 99 | 1/5 |
| | Example 10 | | | | |
| | Comparative | 10 | 696 | 98 | 2/5 |
| | Example 11 | | | | |
| TOP | Comparative | 0.5 | 701 | 99 | 5/5 |
| | Example 12 | | | | |
| | Comparative | 1 | 699 | 99 | 5/5 |
| | Example 13 | | | | |
| | Comparative | 3 | 698 | 99 | 5/5 |
| | Example 5 | | | | |
| | Comparative | 5 | 698 | 99 | 5/5 |
| | Example 14 | | | | |
| | Comparative | 10 | 695 | 97 | 5/5 |
| | Example 15 | | | | |

When TOP was used, even if the added amount was less than 3 mass %, the separator was wetted with the electrolyte at the normal pressure. However, when DME was used, if the added amount was less than 3 mass %, the separator was not wetted with the electrolyte at the normal pressure. On the other hand, at the reduced pressure (338 hPa), even if the added amount was less than 3 mass %, the separator was sufficiently wet with the electrolyte. Other additives showed the same tendency as TOP (the results are not shown in Table 3). It is noted that an amount to be added to the electrolyte of less than 3% is sufficient at a reduced pressure.

However, an occurrence of abnormalities of batteries was 5/5, i.e, all batteries had problems, when TOP was used (Comparative Examples 5, 12˜15). There was no improvement regardless of the amount of TOP. When DME was used in an amount of more than 3 mass %, it was noted that safety was reduced. Batteries using 10 mass % of TOP or DME showed a slight reduction in capacity and capacity maintenance rate.

The results are believed to depend on various factors. For example, when an amount of an additive is increased, solubility of lithium ion solute and electrolyte conductivity of an electrolyte are reduced; when an amount of the additive in a battery is increased, delay of decomposition of the additive at overcharge occurs and it takes a long time to shut down a separator, and the like. Therefore, an amount of the wettability improving agent is preferably less than 3 mass %. It is preferable to minimize the amount in a range which is capable of improving wettability. A compound which is not consumed during normal use of a battery by a side effect and the like is preferred.

Batteries of Example 12 and Comparative Example 16 were prepared. In Experiment 5, a combination of a nonaqueous solvent not having substantial wettability and a wettability improving agent which improves the wettability thereof is also preferable for a polymer electrolyte battery.

### EXAMPLE 12

Tripropylene glycol diacrylate and the electrolyte in Example 1 were mixed at a ratio of 1:18. A prepolymer composition containing 5000 ppm of t-hexyl peroxy pivalate as a polymerization initiator was added to the mixture and the mixture was heated at 80° C. for 3 hours to cure and to prepare a gel polymer electrolyte. The gel polymer electrolyte and a power generation element comprising a separator made of polyethylene which was sandwiched between a positive electrode sheet and a negative electrode sheet were placed in an outer cover. Edges of the outer cover were sealed by anastomosis to prepare a polymer battery.

### COMPARATIVE EXAMPLE 16

A battery of Comparative Example 16 was prepared in the same manner as the battery of Example 12 except that trioctyl phosphate (TOP) was used instead of 1,2-dimethoxyethane (DME).

[Experiment 5]

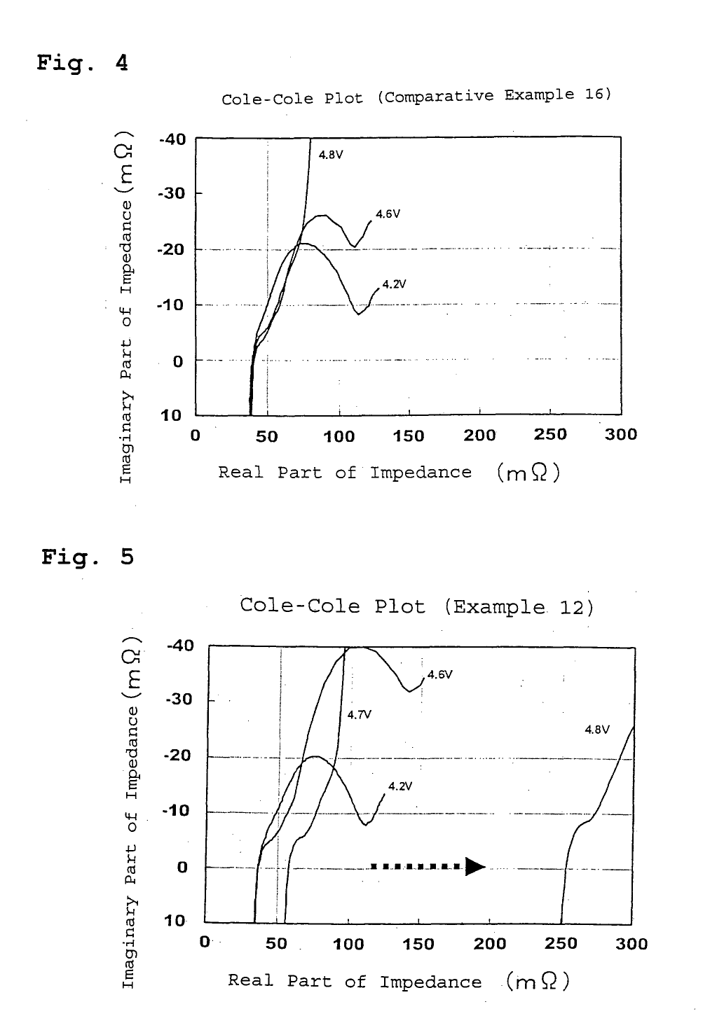

Batteries of Example 12 and Comparative Example 16 were charged at a constant current of 700 mA to 4.2 V˜4.8 V to measure internal resistance (impedance) at each charge voltage point. The results are shown in FIGS. 4 and 5.

A bulk resistance of the polymer battery of Comparative Example 16 was essentially constant at a charge voltage point in a range of 4.2 V˜4.8 V as shown in FIG. 4. In the polymer battery of Example 12, a bulk resistance increased from 36 mΩ (4.2 V) to 256 mΩ (4.8 V) (about a 7 time increase in the bulk resistance), in a range of 4.2 V˜4.8 V.

The polymer battery of Example 12 had excellent charcteristics of battery capacity, capacity maintenance rate and overcharge test results (3.0 It), similar to the battery of Example 1.

Both a polymer battery and non polymer battery of the present invention can be provided with the shut down property of a separator at a early stage of overcharge by a wettability improving agent and have excellent safety at overcharge.

The bulk resistance of the battery, a non polymer battery, of Example 1 containing the same wettability improving agent, DME, as Example 12 increased 5 times in a range of 4.2 V˜4.8 V. Therefore, the shut down effect of a separator in a polymer battery is stronger than that in a non polymer battery.

Two reasons why the shut down effect of a separator is greater for the polymer battery can be considered.

\mathring{1} Adhesion of a positive electrode and a separator is strong in the polymer battery, a positive electrode potential easily passes to the separator and a wettability improving agent contained in the separator is easily decomposed.

\mathring{2} The electrolyte is fixed by a polymer and an amount of movable electrolyte is little in the gel polymer electrolyte battery to fix the relative location of the wettability improving agent and the separator. As a result, the wettability improving agent is efficiently decomposed.

Advantages of the Invention

The present invention provides a lithium secondary battery having a highly reliable self-operating safety mechanism. The lithium secondary battery of the present invention not having an external safety mechanism such as a protective circuit is sufficiently safe for overcharge. According to the present invention, a lithium secondary battery having a high capacity and excellent safety can be provided at a reasonable cost.

What is claimed is:

1. A lithium secondary battery comprising a positive electrode which is capable of occluding and releasing lithium, a negative electrode which is capable of occluding and releasing lithium, a separator between the positive electrode and the negative electrode, and a nonaqueous electrolyte comprising a nonaqueous solvent and a wettability improving agent,
wherein the nonaqueous solvent does not have substantial wettability to the separator,
the wettability improving agent is dissolved in the nonaqueous solvent, improves wettability of the nonaqueous solvent to the separator, and has an oxidative decomposition potential in a range of 4.5 V to 6.2 V based on the potential of a lithium reference electrode.

2. The lithium secondary battery according to claim 1, wherein the oxidative decomposition potential of the wettability improving agent is smaller than that of the nonaqueous solvent.

3. The lithium secondary battery according to claim 1, wherein a reductive decomposition potential of the wettability improving agent is not greater than 0.0 V.

4. The lithium secondary battery according to claim 2, wherein a reductive decomposition potential of the wettability improving agent is not greater than 0.0 V.

5. The lithium secondary battery according to claim 1, wherein a mass ratio of the wettability improving agent relative to the nonaqueous solvent is not greater than 3 mass %.

6. The lithium secondary battery according to claim 2, wherein a mass ratio of the wettability improving agent relative to the nonaqueous solvent is not greater than 3 mass %.

7. The lithium secondary battery according to claim 3, wherein a mass ratio of the wettability improving agent relative to the nonaqueous solvent is not greater than 3 mass %.

8. The lithium secondary battery according to claim 4, wherein a mass ratio of the wettability improving agent relative to the nonaqueous solvent is not greater than 3 mass %.

9. The lithium secondary battery according to claim 1, wherein the oxidative decomposition potential of the wettability improving agent is in a range of 4.8 V to 5.2 V.

10. The lithium secondary battery according to claim 2, wherein the oxidative decomposition potential of the wettability improving agent is in a range of 4.8 V to 5.2 V.

11. The lithium secondary battery according to claim 3, wherein the oxidative decomposition potential of the wettability improving agent is in a range of 4.8 V to 5.2 V.

12. The lithium secondary battery according to claim 4, wherein the oxidative decomposition potential of the wettability improving agent is in a range of 4.8 V to 5.2 V.

13. The lithium secondary battery according to claim 5, wherein the oxidative decomposition potential of the wettability improving agent is in a range of 4.8 V to 5.2 V.

14. The lithium secondary battery according to claim 6, wherein the oxidative decomposition potential of the wettability improving agent is in a range of 4.8 V to 5.2 V.

15. The lithium secondary battery according to claim 7, wherein the oxidative decomposition potential of the wettability improving agent is in a range of 4.8 V to 5.2 V.

16. The lithium secondary battery according to claim 8, wherein the oxidative decomposition potential of the wettability improving agent is in a range of 4.8 V to 5.2 V.

17. The lithium secondary battery according to claim 1, wherein the separator comprises polyethylene, the electrolyte comprises a mixture of ethylene carbonate and γ-butyrolactone and the wettability improving agent is selected from the group consisting of 1,2-dimethoxyethane (DME), tetrahydrofuran (THF), 2-methyltetrahydrofuran (2-MeTHF), 1,3-dioxolane (DOL), 4-methyl-1,3-dioxolane (4-MeDOL), N,N-dimethylformamide (DMF), N-methylpyrrolidone (NMP), methyl formate (MF) and dimethyl sulfoxide (DMSO).
